(19) United States
(12) Patent Application Publication
(10) Pub. No.: US 2011/0319066 A1
(43) Pub. Date: Dec. 29, 2011

(54) APPARATUS AND METHOD FOR RELAYING CONTENT BETWEEN A MACROCELL AND A FEMTOCELL

(75) Inventors: Chie-Ming Chou, Qingshui Town (TW); Jung-Mao Lin, Dali City (TW)

(73) Assignee: Industrial Technology Research Institute

(21) Appl. No.: 12/974,288

(22) Filed: Dec. 21, 2010

Related U.S. Application Data
(60) Provisional application No. 61/358,346, filed on Jun. 24, 2010.

(51) Int. Cl. H04W 74/08

(52) U.S. Cl. 455/422.1

(57) ABSTRACT

An apparatus is provided for relaying content between a macro base station and a femto base station of a femtocell whose geographic area of coverage is at least partially overlapped by a macrocell including the macro base station. As a user equipment, the apparatus may receive information, including a random access code, which has been coordinated between the macro base station and femto base station. The apparatus may prepare the random access code for transmission on a random access channel to the macro/femto base station in an instance in which the other of the macro/femto base station is serving the apparatus. The code serves to notify the macro/femto base station that the apparatus has been selected to relay content between the macro base station and femto base station. And consequently, the apparatus may also relay content between the macro base station and femto base station.

### CROSS-REFERENCE TO RELATED APPLICATIONS

The present application claims priority to U.S. Provisional Patent Application No. 61/358,346, entitled: Method of Communication between Femtocell and Macrocell through User Entity, filed on Jun. 24, 2010, the content of which is incorporated herein by reference.

### FIELD

Example embodiments generally relate to operation of a wireless network, and more particularly, relate to operating a network including a macrocell and a femtocell.

### BACKGROUND

A femto base station, also known as an access point base station, is a smaller version of a cellular telephone tower, which are owned and operated by telecommunication companies. These towers provide coverage over large areas of a communication network, or “macro network.” Such communication network may be a radio network, which is a network system distributing programming to multiple stations simultaneously, or slightly delayed, for the purpose of extending total coverage beyond the limits of a single broadcast signal. The area of coverage of each such tower is sometimes referred to as a “macrocell.” The area of coverage of a femto base station is referred to as a “femtocell.” Localized femtocells may be established within and overlying portions of macrocells to handle areas with relatively dense concentrations of mobile users, and may be designed and located for use in residential or small business environments.

A femtocell is a low-power wireless access point that operates in a licensed spectrum to connect standard mobile devices to a mobile operator's network. For example, a femtocell currently enables 2 to 8 mobile phones to connect to the service provider's network via broadband, such as DSL or cable, and allows the service provider to extend service coverage indoors, especially where access to the macro network would otherwise be limited or unavailable. When used in dense deployments, femtocells have the potential of delivering an order of magnitude more capacity than the macrocell alone.

The benefits of femtocells can be explained from two aspects. From the operator's viewpoint, the benefits include (1) reduced backhaul capacity requirements; (2) increased wireless capacity; (3) reduced coverage holes and creating of new converged services. From the customer's viewpoint, the benefits includes (1) superior in-building coverage and quality without change in phones; and (2) one number and one phone and location specific pricing.

Femtocells may belong to either a Closed Subscriber Group (CSG) or an Open Subscriber Group (OSG). A CSG femto base station is accessible only to a set of pre-defined or authorized user stations. In emergency situations, however, a CSG may allow non-registered user stations to access the femto base station. Unlike a CSG, the base station of an OSG is accessible to any user station.

Femto base stations are relatively inexpensive, easy to install, and provide the above described benefits. The use of femto base stations may also increase overall connectivity in the wireless network environment by increasing the number of base stations in a given area.

### SUMMARY

In light of the foregoing background, exemplary embodiments provide an improved apparatus and method medium for relaying content (“exemplary” as used herein referring to “serving as an example, instance or illustration”). According to one exemplary embodiment of the disclosure, an apparatus is provided. The apparatus includes a processor configured to perform or cause the apparatus to perform a number of operations. The operations include receiving information at the apparatus operable as a user equipment. The information, which has been coordinated between a macro base station and a femto base station of a femtocell whose geographic area of coverage is at least partially overlapped by a macrocell including the macro base station, includes a random access code.

The operations also include preparing the random access code for transmission on a random access channel to the macro base station or femto base station as a first base station in an instance in which the other of the macro base station or femto base station as a second base station is serving the apparatus. This code serves to notify the first base station that the apparatus has been selected to relay content between the first base station and second base station. And consequently, the operations also include relaying content between the first base station and second base station, including receiving content from the first base station or second base station and preparing the content for transmission to the second base station or first base station.

According to another exemplary embodiment of the disclosure, an apparatus is provided that includes a processor configured to perform or cause the apparatus to perform a number of operations. The operations of this other exemplary embodiment include coordinating information including a random access code between the apparatus as a macro base station or a femto base station of a femtocell whose geographic area of coverage is at least partially overlapped by a macrocell including the macro base station, where the other of the macro base station or femto base station is a second base station. The coordinated information includes a random access code, and the operations also include receiving the random access code on a random access channel from a user equipment in an instance in which the second base station is serving the user equipment. The code serves to notify the apparatus that the user equipment has been selected to relay content between the apparatus and second base station.

The operations of this other exemplary embodiment also include participating in a relay of content, by the user equipment, between the apparatus and second base station. Participation in the relay of content includes preparing content for transmission to the user equipment to thereby enable the user equipment to transmit the content to the second base station, or receiving content from the user equipment having received the content from the second base station for transmission to the apparatus.

According to yet another exemplary embodiment of the disclosure, an apparatus is provided that includes a processor configured to perform or cause the apparatus to perform a number of operations. The operations of this exemplary embodiment include coordinating information between the apparatus as a macro base station or a femto base station of a femtocell whose geographic area of coverage is at least partially overlapped by a macrocell including the macro base station, where the other of the macro base station or femto base station is a second base station. The information includes a random access code, and the operations also include preparing the random access code for transmission to a user equipment in an instance in which the apparatus is serving the user equipment. The user equipment is thereby enabled to transmit the random access code to the second base station, where the code serves to notify the second base station that the user equipment has been selected to relay content between the apparatus and second base station.

The operations also include participating in a relay of content, by the user equipment, between the apparatus and second base station. Participation in the relay of content includes preparing content for transmission to the user equipment to thereby enable the user equipment to transmit the content to the second base station, or receiving content from the user equipment having received the content from the second base station for transmission to the apparatus.

According to a further exemplary embodiment of the disclosure, a method is provided that includes operations performed by an apparatus including a processor configured to at least perform or cause the apparatus to at least perform the respective operations. The operations include receiving information at the apparatus operable as a user equipment. The information, which has been coordinated between a macro base station and a femto base station of a femtocell whose geographic area of coverage is at least partially overlapped by a macrocell including the macro base station, includes a random access code.

The operations also include preparing the random access code for transmission on a random access channel to the macro base station or femto base station as a first base station in an instance in which the other of the macro base station or femto base station as a second base station is serving the apparatus. This code serves to notify the first base station that the apparatus has been selected to relay content between the first base station and second base station. And consequently, the operations also include relaying content between the first base station and second base station, including receiving content from the first base station or second base station and preparing the content for transmission to the second base station or first base station.

According to a still another exemplary embodiment of the disclosure, a method is provided that includes operations performed by an apparatus including a processor configured to at least perform or cause the apparatus to at least perform the respective operations. The operations of this other exemplary embodiment include coordinating information including a random access code between the apparatus as a macro base station or a femto base station of a femtocell whose geographic area of coverage is at least partially overlapped by a macrocell including the macro base station, where the other of the macro base station or femto base station is a second base station. The coordinated information includes a random access code, and the operations also include receiving the random access code on a random access channel from a user equipment in an instance in which the second base station is serving the user equipment. The code serves to notify the apparatus that the user equipment has been selected to relay content between the apparatus and second base station.

The operations of this other exemplary embodiment also include participating in a relay of content, by the user equipment, between the apparatus and second base station. Participation in the relay of content includes preparing content for transmission to the user equipment to thereby enable the user equipment to transmit the content to the second base station, or receiving content from the user equipment having received the content from the second base station for transmission to the apparatus.

In an additional or alternative exemplary embodiment of the disclosure, a method is provided that includes operations performed by an apparatus including a processor configured to at least perform or cause the apparatus to at least perform the respective operations. The operations of this exemplary embodiment include coordinating information between the apparatus as a macro base station or a femto base station of a femtocell whose geographic area of coverage is at least partially overlapped by a macrocell including the macro base station, where the other of the macro base station or femto base station is a second base station. The information includes a random access code, and the operations also include preparing the random access code for transmission to a user equipment in an instance in which the apparatus is serving the user equipment. The user equipment is thereby enabled to transmit the random access code to the second base station, where the code serves to notify the second base station that the user equipment has been selected to relay content between the apparatus and second base station.

The operations also include participating in a relay of content, by the user equipment, between the apparatus and second base station. Participation in the relay of content includes preparing content for transmission to the user equipment to thereby enable the user equipment to transmit the content to the second base station, or receiving content from the user equipment having received the content from the second base station for transmission to the apparatus.

### BRIEF DESCRIPTION OF THE DRAWINGS

Having thus described the disclosure in general terms, reference will now be made to the accompanying drawings, which are not necessarily drawn to scale, and wherein:

FIGS. 1 and 2 are schematic block diagrams illustrating components of a system for implementing exemplary embodiments of the disclosure;

FIG. 3 is a schematic block diagram of an apparatus that may be configured to operate as a macro base station, user equipment, femto base station, operator network macrocell management system or femtocell management system, in accordance with exemplary embodiments;

FIG. 4 is a schematic block diagram illustrating components of a system arranged according to one example scenario in which example embodiments of the disclosure may be employed;

FIGS. 5-7 are control flow diagrams illustrating messages that may be exchanged in the scenario illustrated in FIG. 4, in accordance with example embodiments;

FIG. 8 is a schematic block diagram illustrating components of a system arranged according to another example scenario in which example embodiments of the disclosure may be employed; and

FIGS. 9-12 are control flow diagrams illustrating messages that may be exchanged in the scenario illustrated in FIG. 8, in accordance with example embodiments.

### DETAILED DESCRIPTION

Exemplary embodiments now will be described more fully hereinafter with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

The terms “data,” “content,” “information” and similar terms may be used interchangeably, according to some example embodiments, to refer to data capable of being transmitted, received, operated on, and/or stored. The term “network” may refer to a group of interconnected computers or other computing devices, which may be interconnected directly or indirectly by various means including via one or more switches, routers, gateways, access points or the like. As also described herein, various messages or other communication may be transmitted or otherwise sent from one component or apparatus to another component or apparatus. It should be understood that transmitting a message or other communication may include not only transmission of the message or other communication, but may also include preparation or otherwise generation of the message or other communication by a transmitting apparatus or various means of the transmitting apparatus.

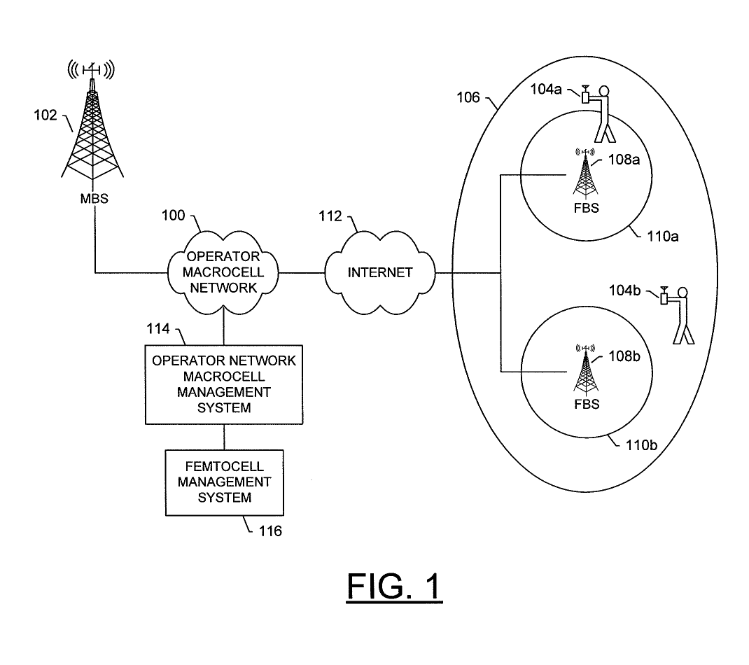

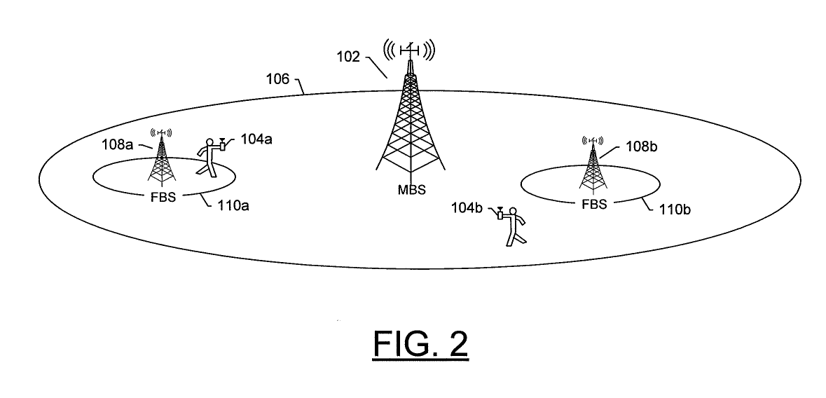

FIGS. 1 and 2 are schematic block diagrams illustrating components of an exemplary system for implementing exemplary embodiments. The system may include one or more wireless communications networks. Examples of such networks include 3GPP radio access networks, Universal Mobile Telephone System (UMTS) radio access UTRAN (Universal Terrestrial Radio Access Network), Global System for Mobile Communications (GSM) radio access networks, Code Division Multiple Access (CDMA) 2000 radio access networks, Wireless Local Area Networks (WLANs) such as IEEE 802.xx networks (e.g., 802.11a, 802.11b, 802.11g, 802.11n, etc.), world interoperability for microwave access (WiMAX) networks, IEEE 802.16, and/or wireless Personal Area Networks (WPANs) such as IEEE 802.15, Bluetooth, low power versions of Bluetooth, infrared (IrDA), ultra wideband (UWB), Wibree, Zigbee or the like. 3GPP radio access networks may include, for example, 3G (e.g., GERAN) 3.9G (e.g., UTRAN Long Term Evolution (LTE) or Super 3G) or E-UTRAN (Evolved UTRAN), 4G networks or the like.

As shown, the system includes a wireless network 100 configured to distribute programming to users simultaneously, or with small delay, for the purpose of extending total coverage beyond the limits of a single signal. The network may be considered a macrocell network and includes one or more infrastructure components such as macro base stations (MBSs) 102. The MBS may be configured to communicate with one or more user equipment (UE) 104 (or mobile stations, mobile terminals, etc.) to transmit and receive voice and data information via the network(s)—two UEs being shown as UE 104a and 104b. Although a specific number of BSs and UEs are shown, FIGS. 1 and 2 are exemplary and any numbers of BSs and UEs may be provided. Furthermore, the functions provided by one or more devices of system may be combined, substituted, or re-allocated among various devices.

The MBS 102 may include any appropriate apparatus or system that facilitates communication between a UE 104 and the operator's macrocell network 100. For example, in some embodiments, the MBS may include a wireless communication device installed at a fixed location in a macrocell 106 or defined geographic region of network coverage. The system includes one or more additional BSs that are similar to the MBS 102 but create a smaller geographic region of coverage. These BSs may be referred to as femto base stations (FBSs) 108 (two being shown as FBSs 108a, 108b), and their geographic region of coverage may be referred to as a femtocell 110 (two being shown as femtocells 110a, 110b). As described herein, a BS may refer to either a MBS or FBS. These FBSs may be coupled to the macrocell network in any of a number of different manners, but in one example embodiment, may be coupled to the macrocell network via the Internet 112 or another public network. Further, although described herein as an FBS of a femtocell, example embodiments of the disclosure are equally applicable to other technologies for defining a cell or other geographic region, such as a microcell, picocell, WLAN or the like, that may be at least partially overlapped by a macrocell.

The operator network 100 may operate or direct operation of one or more MBS 102 to create a macrocell network, and may operate or direct operation of a FBS to create a femtocell network. The operator network may include one or more management systems configured to facilitate communication between the various components of the system. These management systems may include an operator network macrocell management system 114 and femtocell management system 116. Although shown as separate systems, in some example embodiments, one apparatus may support the operator network macrocell management system and femtocell management system, logically separated but co-located within the apparatus.

The MBS 102 and FBS 108 may include any of a number of different types of apparatuses such as, for example, a node B or eNB (e.g., macro eNB—MeNB), a base transceiver system (BTS), an access point, a home BS, node B or eNB (e.g., home eNB—HeNB), or the like. In other example embodiments, the MBS may be a relay station, an intermediate node, or an intermediary. The MBS and FBS may include any appropriate type of wireless or radio BS, such as a land-based communication BS or a satellite-based communication BS. The MBS and FBS may include any appropriate type voice, data, and/or integrated voice and data communication equipment to provide high speed data and/or voice communications. In other example embodiments, any other type of MBS or FBS or equivalent thereof may be used.

The UE 104 may be any type of device for communicating with a MBS 102 (e.g., MeNB) and FBS 108 (e.g., HeNB). For example, a UE may be a mobile communication device, or any other appropriate computing platform or device capable of exchanging data and/or voice information with a BS such as servers, clients, desktop computers, laptop computers, network computers, workstations, personal digital assistants (PDA), tablet PCs, scanners, telephony devices, pagers, cameras, musical devices, etc. A UE may be a fixed computing device operating in a mobile environment, such as, for example, a bus, a train, an airplane, a boat, a car, etc. In some embodiments, a UE may be configured to communicate with a BS using any of the various communication standards supporting mobile communication devices. The UEs may be configured to communicate with other UEs (not shown) directly or indirectly via a BS or computing systems (not shown) using wired or wireless communication methods.

As shown in FIG. 1, and more particularly in FIG. 2, the macrocell 106 may overlap if not completely cover a number of femtocells 110, thereby facilitating sufficient service coverage such that a UE 104 entering a femtocell may maintain an uninterrupted communication link. According to various example embodiments, more than one macrocell may overlap a femtocell.

As described herein, a macro UE (MUE) may refer to a UE 104 serviced by a MBS 102, and a femto or home UE (HUE) may refer to a UE serviced by a FBS 108. In the example shown in FIGS. 1 and 2, at their respective geographic locations, UE 104a may be considered a femto or home UE in an instance in which the UE is authorized to access that femto, and UE 104b may be considered a macro UE—although their status as a femto or macro UE may change as the respective UEs move and their geographic locations change relative to the macrocell 106 and femtocells 110.

Small geographic areas such as structures are particularly suitable for a femtocell because service may be maintained using a FBS 108 to provide service inside the structure, although it should be understood that a femtocell may be implemented in any of a number of different types of geographic areas. Examples of suitable structures include homes, offices, libraries, businesses, restaurants, theaters, and any other places where wireless service is desired and obstructed. Structures are typically constructed out of wood, steel, concrete, and other building materials that may degrade a radio frequency (RF) signal. Because RF signals may not effectively penetrate common building materials used today, the RF signal may degrade to the point where a mobile client device within the structure may not receive enough of the signal to maintain a communication link with a MBS 102 of any overlapping macrocell 106.

When service is provided through the Internet 112 to a FBS 108, the service may be communicated using a broadband signal. In such instances, the FBS may receive the broadband signal and convert the signal into an RF signal for propagation to any UEs in the respective femtocell 110. In instances in which a UE 104 and FBS are disposed inside a structure, the UE may receive a stronger service signal from the FBS than the UE may otherwise receive from the MBS 102 of the overlapping macrocell 106. Inside the structure, the RF signal provided by the MBS may be degraded as it passes through the building materials of the structure.

Without a femtocell 110, the RF signal provided by the MBS 102 of the macrocell 106 may be degraded as it passes through the building materials of the structure, such that a UE 104 inside the structure may lose a service connection link. Once a femtocell network is created, however, the RF service signal provided by the FBS 108 to the UE inside the structure may be of sufficient strength to provide service to the UE. In this instance, the RF signal provided by the FBS may not be degraded by traveling through the building materials comprising the outer walls of the structure because the signal emanates from the FBS inside the structure. Thus the signal may be sufficiently strong to maintain a service connection inside the structure.

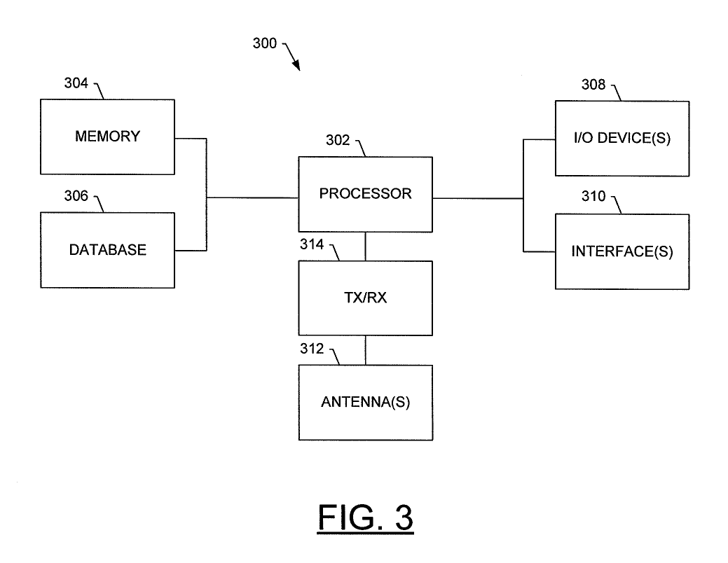

FIG. 3 illustrates a block diagram of an apparatus 300 that may be configured to operate as a MBS 102, UE 104, FBS 108, operator network macrocell management system 114 or femtocell management system 116, in accordance with exemplary embodiments. As shown in FIG. 3, apparatus may include one or more of the following components: at least one processor 302 configured to execute computer readable instructions to perform various processes and methods, at least one memory 304 configured to access and store information and computer readable instructions, at least one database 306 to store tables, lists or other data structures, at least one I/O device 308, at least one interface 310, at least one antenna 312 and/or at least one transceiver 314.

The processor 302 may include a general purpose processor, application specific integrated circuit (ASIC), embedded processor, field programmable gate array (FPGA), microcontroller, or other like device. The Processor may be configured to act upon instructions and data to process data output from transceiver 314, I/O devices 308, interfaces 310 or other components that are coupled to processor. In some exemplary embodiments, the processor may be configured to exchange data or commands with the memory 304. For example, the processor may be configured to receive computer readable instructions from the memory and perform one or more functions under direction of the respective instructions.

The memory 304 may include a volatile or non-volatile non-transitory computer-readable storage medium configured to store data as well as software, such as in the form of computer readable instructions. More particularly, for example, the memory may include volatile or non-volatile semiconductor memory devices, magnetic storage, optical storage or the like. The memory may be distributed. That is, portions of the memory may be removable or non-removable. In this regard, other examples of suitable memory include Compact Flash cards (CF cards), Secure Digital cards (SD cards), Multi-Media cards (MMC cards) or Memory Stick cards (MS cards) or the like. In some exemplary embodiments, the memory may be implemented in a network (not shown) configured to communicate with the apparatus 300.

The database 306 may include a structured collection of tables, lists or other data structures. For example, the database may be a database management system (DBMS), a relational database management system, an object-oriented database management system or similar database system. As such, the structure may be organized as a relational database or an object-oriented database. In other exemplary embodiments, the database may be a hardware system including physical computer-readable storage media and input and/or output devices configured to receive and provide access to tables, lists, or other data structures. Further, hardware system database may include one or more processors and/or displays.

The I/O devices 308 include any one or more of a mouse, stylus, keyboard, audio input/output device, imaging device, printing device, display device, sensor, wireless transceiver or other similar device. The I/O devices may also include devices that provide data and instructions to the memory 304 and/or processor 302.

The interfaces 310 may include external interface ports, such as USB, Ethernet, FireWire®, and wireless communication protocols. The interfaces may also include a graphical user interface, or other humanly perceivable interfaces configured to present data, including but not limited to, a portable media device, traditional mobile phone, smart phone, navigation device, or other computing device. The apparatus 300 may be operatively connected to a network (not shown) via a wired and/or wireless communications link using the interface.

The transceiver 314 may include any appropriate type of transmitter and receiver to transmit and receive voice and/or data from other apparatuses (e.g., MBS 102, UE 104, FBS 108, operator network macrocell management system 114, femtocell management system 116). In some exemplary embodiments, the transceiver may include one or a combination of desired functional component(s) and processor(s) to encode/decode, modulate/demodulate and/or perform other wireless communication-channel-related functions. The transceiver may be configured to communicate with an antenna 312 (e.g., single antenna or antenna array) to transmit and receive voice and/or data in one of various transmission modes.

In a number of conventional, arbitrary deployments of macrocells and femtocells, interference may result between the macrocells and femtocells. Because femtocells require no network planning, operators often do not know where, if any, individual femtocells are deployed and cannot reconfigure their macrocell network in order to account for the individual femtocells. Consequently, interference may result from the lack of unique spectrums for femtocell networks and inadequate spectrum planning in the wider network.

For example, a network operator might license a single frequency in the frequency band of 1800 MHz to deploy a macrocell and multiple femtocells. Because femtocells only work in the frequencies licensed to the network they are in, the same frequency may be utilized by the macrocell and femtocells. Consequently, a macro UE near a femtocell may experience interference from the FBS. Similarly, a femto UE near the MBS of an overlapping macrocell may experience interference from the MBS. In the case of an interfering femtocell, the interference may be resolved by a handover of the UE from the macrocell to the femtocell. However, handover may not be an option when the femtocell belongs to a CSG, in which the service is limited to registered users. Consequently, in networks with CSGs, transmissions from a MBS to a macro UE may suffer from a near-far problem in which a signal received by the macro UE from a nearby FBS is stronger than, and may mask, a signal received from the MBS located further away. For example, a UE that is located closer to transmitter A than it is from transmitter B may receive more power from the nearby transmitter A. The UE in this case may treat signals from transmitter B as noise, and signals from transmitter A may become difficult, if not impossible, to be understood and decoded. Another case in networks with CSGs, transmission from a macro UE to its MBS may raise a near-far problem for a FBS in which a signal received from a Femto UE is weaker than and may mask by a signal from the macro UE.

To facilitate mitigating interference between a femtocell 110 and overlapping macrocell 106, and achieve higher spectrum efficiency, inter-cell interference coordination (ICIC) techniques may be employed. In accordance with a number of these techniques, the MBS 102, FBS 108 and/or UEs 104 exchange appropriate information to permit the BSs to assign or otherwise allocate radio resources such that interference is reduced or otherwise mitigated. In one example, radio resource assignments may be made by time-domain partitioning and frequency-domain partitioning resources such that the allocation of resources to femto UEs and macro UEs may be separated. In another example, downlink (DL) transmission power may be adjusted to a suitable value to reduce interference.

In another example technique for facilitating mitigating interference and achieving higher spectrum efficiency, a UE 104 may be cooperatively served by a MBS 102 and FBS 108 in accordance with a so-called coordinated multiple point transmission and reception (CoMP) technique. The CoMP technique may be categorized into two modes, namely joint transmission and dynamic cell selection. In joint transmission, both the MBS and FBS may simultaneously serve the UE with same operating frequency, and then the diversity gain may be achieved to make more robust and better transmission. In dynamic cell selection, the MBS or FBS may switchably serve the UE based one or more of a number of different factors such as the UE's channel quality or QoS requirements. To support dynamic cell selection, coordination between the MBS and FBS is often required.

To most effectively implement techniques such as ICIC and CoMP, it may be beneficial for the MBS 102, FBS 108 and/or UE 104 to quickly exchange or otherwise transmit or receive information to accurately reflect the current channel conditions. Unfortunately, there may be no direct interface between the MBS and FBS, and an appropriate backhaul interface may not be available or may not be sufficiently fast and reliable. As an alternative, messages may be transmitted and received over an air interface between the BSs, either directly or via a UE. In a first instance in which the BSs exchange messages directly, the BS serving the UE may be required to stop serving the UE to deliver a message to the other BS, which may negatively impact the UE. In a second instance in which a UE relays messages between the BSs, it may be the case that only one UE is selected to relay the messages, which may result in a lower impact on all of the UEs served by one of the BSs. However, the second instance may require a two-step transmission, resulting in a longer latency than in the first instance.

In view of the foregoing, example embodiments of the disclosure therefore provide techniques whereby a UE may relay messages carrying information between a MBS and FBS with reduced latency and reduced radio resources to facilitate the BSs implementing techniques such as ICIC and CoMP. Generally, in accordance with example embodiments of the disclosure, the system may be configured to enable UE relaying such as during initialization of one or more of the MBS, FBS and at least one UE. During configuration of the system, the MBS, FBS and/or UE may perform a negotiation to assign, acquire, establish and/or exchange information useful to carry out UE relaying. This information may include, for example, a specific random access code assigned for performing a contention-free random access procedure. The specific code may be provided by the UE to the BS (e.g., MBS) not currently serving the UE to thereby notify the respective BS that the UE has been selected to relay messages between the MBS and FBS. Although described as a random access code, it should be understood that the random access code may be another type of code, indicator or the like.

The information assigned, acquired, established and/or exchanged during the negotiation may additionally or alternatively include a temporary identifier such as a radio network transaction identifier (RNTI) assigned to the FBS (e.g., H-RNTI) or UE (e.g., C-RNTI). Further, the information may additionally or alternatively include synchronization information of the MBS, FBS and/or UE with one another. And in various instances, the information may additionally or alternatively include a contention-based temporary identifier (e.g., CB-RNTI) that may be mapped to a contention-based resource allocation.

Following configuration of the system for UE relaying, in various instances, the system may carry out UE relaying based on or otherwise using the information assigned, acquired, established and/or exchanged during the negotiation performed by the MBS, FBS and/or UE. This may include, for example, the UE synchronizing with the BS (e.g., MBS) not currently serving the UE. Synchronization of the UE in these instances may involve the UE using its synchronization information with the non-serving BS, performing a contention-free random access procedure with the non-serving BS based on the assigned specific random access code, or re-using synchronization information of the serving BS (e.g., FBS) with the non-serving BS. In various instances, the UE may not establish authorization or register with the non-serving BS to relay content to the non-serving BS, and the non-serving BS may not require authorization or registration of the UE to accept content from the UE. In various instances, the non-serving BS may transmit relaying content to the UE in a control conventional random access message without scheduling a resource grant to the UE.

Example embodiments of the disclosure will now be described in a number of applications or scenarios in which the example embodiments may be employed. As described, a UE 104 may be configured to relay messages between cells to enable the cells to facilitate mitigating interference between them, such as in accordance with techniques such as ICIC, CoMP or the like. It should be understood, however, that these scenarios are merely examples and should not be taken to limit the scope of example embodiments of the disclosure. It should be further understood that the UE may be configured to relay messages to enable the cells to implement techniques other than ICIC and CoMP, or to enable the cells to perform any of a number of other functions based on the exchanged messages. For example, the UE may be configured to relay messages to negotiate one or more controls between the MBS and FBS. These controls may include, for example, controls for mobility handling, packet handling, radio resource management handling, scheduling information, antenna configuration information or the like. Moreover, it should be understood that although terminology specific to various technologies may be used herein, example embodiments of the disclosure should not be construed as limited to those technologies. For example, although LTE-specific terminology may be used herein, example embodiments of the disclosure should not be construed as being limited to LTE networks.

A. UE Relaying for DL ICIC

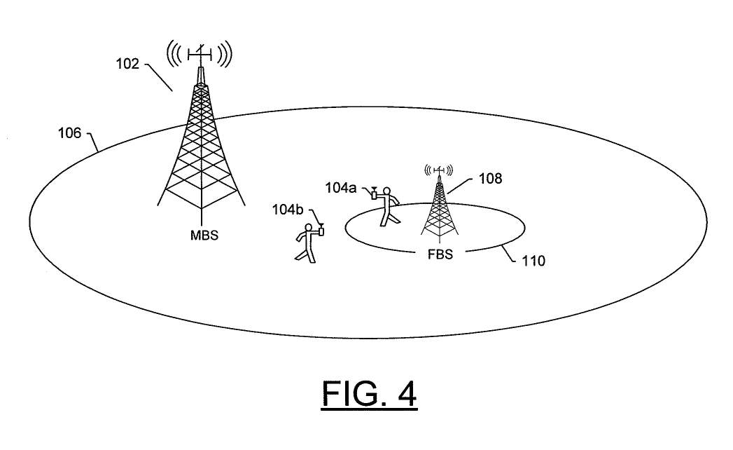

One example scenario in which example embodiments of the disclosure may be employed is shown in FIG. 4. As shown, in an instance in which a macro UE 104b moves into a femtocell 110 belonging to a CSG in which the UE is not a registered user. The UE may experience interference from the FBS 108 that affects its receipt of downlink (DL) signaling from its serving MBS 102, but may not be handed over to the femtocell due to its restricted access. DL ICIC may be implemented by the MBS and FBS to coordinate their transmissions to facilitate mitigating the interference. A femto UE 104a served by the FBS at the same time may be selected to relay messages between the MBS and FBS. The BS of one of the cells may be configured to transmit a coordination message to the femto UE, which in turn may relay or otherwise transmit the message to the BS of the other cell through the air interface.

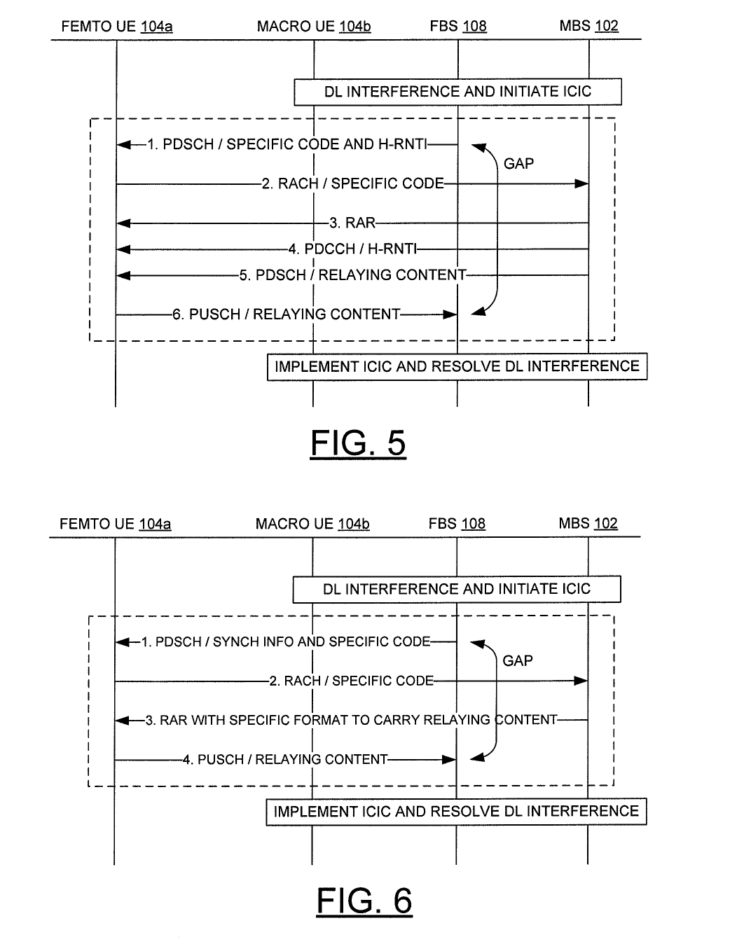

FIG. 5 is a control flow diagram illustrating messages that may be exchanged in the scenario illustrated in FIG. 4 to implement a process or function of UE relaying for DL ICIC, in accordance with one example embodiment of the disclosure. In this example, during configuration of the system, such as during initialization of the FBS 108, the FBS and overlapping MBS 102 may perform a negotiation to establish an assigned first specific random access code and temporary identifier (e.g., H-RNTI). This may be accomplished, for example, via a backhaul connection between the FBS and MBS. The first specific random access code, which may be later transmitted from a femto UE to the MBS, may serve to notify the MBS that the respective femto UE has been selected to relay messages between the MBS and FBS. The first specific random access code may serve to identify the relaying purpose, and may be shared with a number of FBS such as those whose region of coverage the same MBS overlaps. The temporary identifier may serve to identify the FBS to the MBS, and although the temporary identifier may be unique to the FBS, it may alternatively be shared with a number of FBSs such as those whose region of coverage the same MBS overlaps.

As shown, during operation of the system, the macro UE 104b may experience DL interference. In response, the macro UE 104b may notify its serving MBS 102 of an interfering FBS 108. In this regard, the macro UE may try to listen to a cell ID of the FBS, and include it in a notification message transmitted to the MBS using an uplink (UL) data channel. The MBS may respond to this notification by initiating ICIC, including making some coordination determinations.

The macro UE 104b may also transmit to the interfering FBS 108 using its random access channel (RACH), a request or trigger for the FBS to select a femto UE 104a being served by the FBS and begin relaying coordination messages to the overlapping MBS 102 via the selected femto UE. This request may be reflected in a message to the FBS in any of a number of different manners, such as by a specific random access code, which may be the same or different from the first specific random access code. Alternatively, a FBS may try to listen to the signal transmitted from a macro UE, and once the received signal is above a threshold, the FBS may trigger to select a femto UE for relaying.

As shown at operation 1, after selecting a femto UE 104a, the FBS 108 may transmit a message to the selected femto UE using a physical DL shared channel (PDSCH). This message may include the first specific random access code and temporary identifier (e.g., H-RNTI).

As also shown, the FBS 108 may schedule a gap (a period of time)—and may notify the selected femto UE 104a of the gap—during which the FBS may not schedule traffic to the selected femto UE, and during which the femto UE may switch to the MBS 102. During this gap, the FBS may also reduce its transmission power.

At operation 2, after receiving the message from the FBS 108, the femto UE 104a may launch a contention-free random access procedure to synchronize with the MBS 102. During this procedure, the femto UE may transmit the first specific random access code to the MBS using its random access channel (RACH). The femto UE may not establish authorization or register with the MBS, and upon recognition of the first specific random access code as indicating that the respective femto UE has been selected to relay messages between the MBS and FBS, the MBS may not require authorization or registration of the femto UE.

In response to the first specific random access code, the MBS 102 may transmit a random access response to the femto UE 104a. The response may include, at operation 3, a random access response (RAR) message on the MBS's PDSCH that may carry one or more physical parameters to adjust the femto UE's UL synchronization with the MBS. And at operation 4, the response may indicate a scheduled DL resource grant to the temporary identifier (e.g., H-RNTI), which the MBS may transmit on its physical DL control channel (PDCCH). This DL resource may be on the MBS's PDSCH, and may be scheduled after the MBS finishes making its coordination decisions in initiating ICIC.

In response to receipt of the random access response—including the RAR message and DL resource grant, the femto UE 104a may perform any appropriate adjustments based on the physical parameter(s) carried by the RAR message. And at operation 5, the femto UE may begin to decode information transmitted by the MBS using the scheduled PDSCH resources. This information, which may be referred to as relaying content, may include or otherwise reflect the coordination decisions made by the MBS.

At operation 6, after receiving the relay content from the MBS 102, and following expiration of the gap scheduled by the serving FBS 108, the femto UE 104a may switch back to the serving FBS and forward the content to the FBS using the FBS's physical UL shared channel (PUSCH). The FBS may have scheduled the PUSCH resources during or after operation 1. For example, once the FBS schedules the gap for the femto UE to process the relaying, the FBS may also schedule PUSCH resources for the femto UE to forward relaying content after expiration of the gap. Alternatively, for example, the femto UE may also use an UL control channel to transmit an indictor to request a resource for forwarding the relaying content. The MBS and FBS may then implement DL ICIC to coordinate their transmissions to facilitate mitigating the interference.

FIG. 6 is a control flow diagram illustrating messages that may be exchanged in the scenario illustrated in FIG. 4 to implement a process or function of UE relaying for DL ICIC, in accordance with another example embodiment of the disclosure. In this example, during configuration of the system, such as during initialization of the FBS 108, the FBS and MBS 102 may perform a negotiation during which the FBS may synchronize with the overlapping MBS, and the FBS and MBS may establish an assigned first specific random access code. This synchronization may be performed during configuration of the system, but may also be updated at one or more instances thereafter. Similar to the first specific random access code of FIG. 5, the first specific random access code of FIG. 6 may serve to notify the serving MBS 102 that a femto UE has been selected to relay messages between the MBS and FBS. The first specific random access code of FIG. 6 may be the same as the first specific random access code of FIG. 5, or different from the first specific random access code of FIG. 5, which may permit the system to support both embodiments.

During synchronization of the FBS 108 with the MBS 102, the FBS may receive, acquire or otherwise generate synchronization information. This synchronization information may include system information of the MBS such as its station identifier (SI), and may include one or more one or more DL physical parameters of the FBS for DL synchronization with the MBS. Further, for example, the synchronization information may include one or more UL physical parameters of the MBS for UL synchronization with the MBS.

At operation, the process shown in FIG. 6 may begin in a manner similar to that shown in FIG. 5, including a macro UE 104b experiencing DL interference, and in response, notifying its serving MBS 102 of an interfering FBS 108, and requesting or triggering the FBS to select a femto UE 104a to relay coordination messages to the MBS. Similar to before, the MBS may respond to the notification by initiating ICIC, including making some coordination determinations.

At operation 1 of FIG. 6, after selecting a femto UE 104a, the FBS 108 may transmit a message to the selected femto UE using a physical DL shared channel (PDSCH). This message may include the first specific random access code and the FBS's synchronization information for the overlapping MBS 102.

Also similar to the embodiment of FIG. 5, in FIG. 6, the FBS 108 may schedule a gap (a period of time)—and may notify the selected femto UE 104a of the gap—during which the FBS may not schedule traffic to the selected femto UE, and during which the femto UE may switch to the MBS 102, and the FBS may reduce its transmission power.

Upon receipt of the synchronization information of the FBS 108 with the MBS 102, the femto UE 104a may re-use the information to synchronize itself with the MBS without launching a random access procedure to synchronize with the MBS. The femto UE and MBS may, however, exchange messages similar to those exchanged during a random access procedure. Thus, at operation 2, after receiving the first specific random access code and synchronization information of the MBS, the femto UE may re-use the synchronization information and transmit the specific random access code directly to the MBS using its RACH. Similar to before, the femto UE may not establish authorization or register with the MBS, and upon recognition of the first specific random access code as indicating that the respective femto UE has been selected to relay messages between the MBS and FBS, the MBS may not require authorization or registration of the femto UE.

In response to the message including the first specific random access code, the MBS 102 may transmit a random access response to the femto UE 104a. The MBS 102 may interpret the first specific random access code as a notification that the femto UE 104a has been selected to relay messages between the MBS and FBS 108. The first specific random access code in this embodiment may also notify the MBS that adjustment of the femto UE's synchronization may not be necessary. Thus, in this example, the random access response may include a RAR message that carries relaying content instead of including parameters to adjust the femto UE's synchronization with the MBS. As the RAR message includes the relaying content, the MBS may forego scheduling a DL resource grant over which the relaying content may be transmitted to the femto UE, as in FIG. 5. As before, the relaying content may include or otherwise reflect the coordination decisions made by the MBS.

At operation 4, the femto UE 104a may operate in a manner similar to operation 6 of FIG. 5. That is, after receiving the relay content from the MBS 102, and following expiration of the gap scheduled by the serving FBS 108, the femto UE 104a may switch back to the FBS 108 and forward the content to the FBS using the FBS's PUSCH. The MBS and FBS may then implement DL ICIC to coordinate their transmissions to facilitate mitigating the interference.

B. UE Relaying for UL ICIC

As explained above, FIG. 4 illustrates a scenario in which DL ICIC may be employed. FIG. 4 may also be referenced to illustrate a scenario in which UL ICIC may be employed, in accordance with example embodiments of the disclosure. In this scenario, during UL transmission, a power control mechanism may be used during UL transmission to adjust the transmission power of a UE 104 based on the communication distance between the UE and the MBS 102. For example, in an instance in which a macro UE 104b moves into a femtocell 110 located at a distance from the MBS, the macro UE may be requested to increase its transmission power to ensure that the MBS can successfully decode UL signaling form the UE. Due to the increased transmission power, the macro UE's UL transmission power may cause interference with UL transmission of a nearby femto UE 104a and may inhibit the FBS from successfully decoding UL signaling from the femto UE. Accordingly, UL ICIC may be implemented by the MBS and FBS to coordinate their transmissions to facilitate mitigating the interference. Similar to the case of UE relaying for DL ICIC, a femto UE may be selected to relay messages between the MBS and FBS, but in contrast thereto, UE relaying for UL ICIC may involve the femto UE relaying content from the FBS to the MBS.

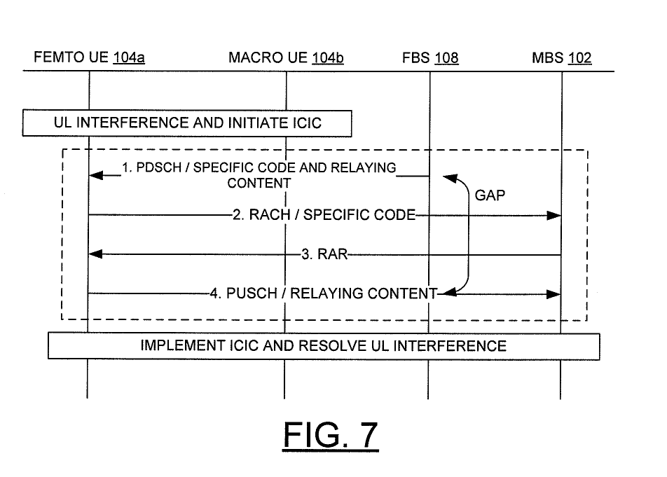

FIG. 7 is a control flow diagram illustrating messages that may be exchanged in the scenario illustrated in FIG. 4 to implement a process or function of UE relaying for UL ICIC, in accordance with one example embodiment of the disclosure. In this example, during configuration of the system, such as during initialization of the FBS 108, the FBS and overlapping MBS 102 may perform a negotiation to establish an assigned second specific random access code and temporary identifier (e.g., H-RNTI). Also during configuration of the system, the FBS 108 may but need not synchronize with the MBS 102, during which the FBS may receive, acquire or otherwise generate synchronization information. The second specific random access code, which may be shared by multiple FBS, may serve to notify the overlapping MBS that a femto UE has been selected to relay messages between the MBS and FBS. The second specific random access code may be the same as or different from the first specific random access code of either or both of FIGS. 5 and 6, which to the extent the random access codes are different, may permit the system to support multiple ones of the embodiments.

As shown, during operation of the system, a FBS 108 may experience UL interference from one or more of its femto UEs 104a. This may be received by the FBS as an indication of a triggering event, such as by an indication of satisfactory DL signal quality but unsatisfactory UL signal quality. In such instances, the FBS may schedule other UL resources for the femto UE. Alternatively, or if scheduling other UL resources does not result in an increase in the UL signal quality, the FBS may trigger UE relaying for and initiate UL ICIC. The FBS triggering UE relaying for UL ICIC may include the FBS selecting a femto UE being served by the FBS to relay coordination messages to the overlapping MBS 102, where this femto UE may be the same or different from the UE by which the FBS is experiencing UL interference. And similar to the MBS initiating DL ICIC, the FBS initiating UL ICIC may include the FBS making some coordination determinations.

As shown at operation 1 of FIG. 7, after triggering UE relaying for and initiating UL ICIC, the FBS 108 may transmit to the selected femto UE 104a using its PDSCH, a message carrying the second specific random access code, temporary identifier (e.g., H-RNTI) and relaying content. Similar to the example embodiment of FIG. 6, in instances in which the FBS synchronizes with the MBS 102 during configuration of the system, the message may also include synchronization information of the FBS with the MBS. Also similar to before, the relaying content may include or otherwise reflect the coordination decisions made by the FBS. More particularly, for example, the relaying content may include resource partitioning information or information reflecting the geographic location of the femto UE by which the FBS is experiencing UL interference.

Also similar to the case of UE relaying for DL ICIC, the FBS 108 in the case of UE relaying for UL ICIC may schedule a gap—and may notify the selected femto UE 104a of the gap—during which the FBS may not schedule traffic to the selected femto UE 104a, and during which the femto UE may switch to the MBS 102, and the FBS may reduce its transmission power.

At operation 2 of FIG. 7, in instances in which the message at operation 1 does not include synchronization information, the femto UE 104a may launch a contention-free random access procedure to synchronize with the MBS 102 and transmit the second specific random access code to the MBS using its RACH. Otherwise, in instances in which the message at operation 1 does include synchronization information, at operation 2, the femto UE may re-use the information to synchronize itself with the MBS, and send the specific random access code directly to the MBS using its RACH. In either instance, the femto UE may not establish authorization or register with the MBS, and upon recognition of the second specific random access code as indicating that the respective femto UE has been selected to relay messages between the MBS and FBS, the MBS may not require authorization or registration of the femto UE.

In response to the message including the second specific random access code, the MBS 102 may transmit a random access response to the femto UE 104a. In instances in which the message at operation 1 does not include synchronization information, the response may include, at operation 3, a RAR message that may carry one or more physical parameters to enable the femto UE to perform UL synchronization with the MBS. Otherwise, in instances in which the message at operation 1 does include synchronization information, the RAR message at operation 3 may be omitted.

The random access response may also indicate a scheduled UL resource grant to the temporary identifier (e.g., H-RNTI), which the MBS may transmit to the femto UE 104a on the MBS's PDCCH. This UL resource may be on the MBS's PUSCH, and may be scheduled by the MBS in response to the second specific random access code. At operation 4, then, the femto UE 104a may forward the relaying content to the MBS 102 using the scheduled PUSCH resources. The MBS and FBS may then implement UL ICIC to coordinate their transmissions to facilitate mitigating the interference.

Through respective operations, a femto UE 104a in the embodiments of FIGS. 5, 6 and 7 may relay one or more messages between the MBS 102 to the FBS 108. As a result, the BSs may apply coordination determinations made by the MBS or FBS to implement DL/UL ICIC. One or more conditions (e.g., action time) under which to implement DL/UL ICIC may also be indicated in the relaying content, and the FBS and MBS may simultaneously implement DL/UL ICIC in accordance with those conditions. Also, if so desired, the messages transmitted and received at one or more of the aforementioned operations may be protected by a retransmission scheme. In such instances in the case of DL ICIC, for example, if the gap expires and the FBS does not receive relaying content from the femto UE, the FBS may treat the process or function of UE relaying for DL ICIC as having failed. In this and other similar instances, the FBS may re-try the process with the same or another femto UE, or attempt to establish a backhaul connection with the MBS.

C. UE Relaying for CoMP (Dynamic Cell Selection Mode)

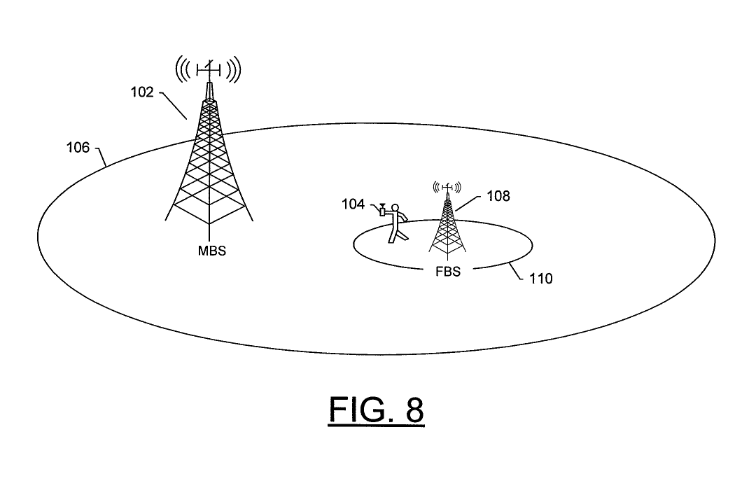

Another example scenario in which example embodiments of the disclosure may be employed is shown in FIG. 8. As explained above, CoMP may be categorized into joint transmission in which the MBS and FBS may simultaneously serve a UE, and dynamic cell selection in which the MBS or FBS may switchably serve to the UE. Example embodiments of the disclosure may include process or function of UE relaying for CoMP, which may be particularly suited for dynamic cell selection. It should be understood, however, that the process or function may also be applicable for joint transmission.

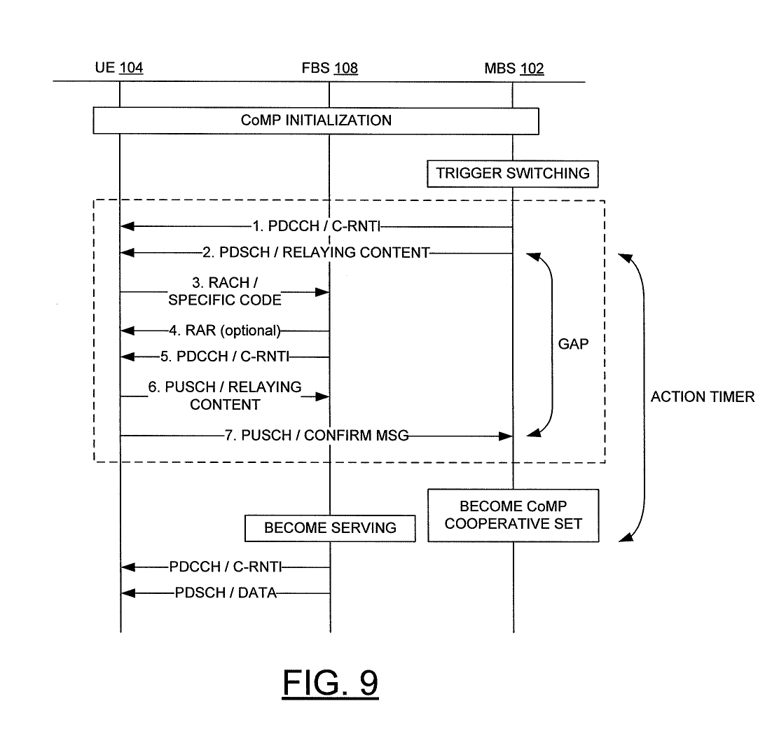

FIG. 9 is a control flow diagram illustrating messages that may be exchanged in the scenario illustrated in FIG. 8 to implement UE relaying for CoMP, in accordance with one example embodiment of the disclosure. In this example, during configuration of the system, such as during initialization of the MBS 102, UE 104 and FBS 108 to perform CoMP, the MBS, UE and FBS may perform a negotiation during which the UE may attempt to ensure sufficient link qualities and acquire appropriate synchronization information associated with the MBS and FBS. Also during this process, the UE may be assigned a temporary identifier (e.g., C-RNTI), and may monitor the PDCCH to elaborate the corresponding PDSCH transmission in both BSs. A security mechanism (key exchange) may also be processed during initialization such that UE need not re-execute authorization and registration while it switches from one BS to the other.

The remaining operations shown in FIG. 9 relate to an instance in which, after initialization of CoMP, the UE 104 desires to switch from the MBS 102 to FBS 108. Similar operations may occur in an instance in which, after initialization, the UE desires to switch from the FBS to MBS.

The MBS 102 may trigger the switch from it to the FBS 108, and at operation 1, may use its PDCCH to transmit the temporary identifier (e.g., C-RNTI) assigned to the UE 104. This identifier may guide the UE to receive data using the MBS's PDSCH.

At operation 2, the MBS 102 may transmit the relaying content to the UE 104 using the MBS's PDSCH. In this context, the relaying content may include an identifier such as the cell ID of a BS to which the UE should switch (e.g., FBS 108). The relaying content may also include, for example, a sequence number (SN), action timer or the like. The SN may serve to notify the target BS of the status of a concurrent packet transmission to maintain in-order transmission after switching. The action timer may serve to coordinate when to exchange the UE's controlling right between the target BS and the currently serving BS (e.g., MBS).

In FIG. 9, the MBS 102 may schedule a gap (a period of time)—and may notify the selected UE 104 of the gap—during which the MBS may not schedule traffic to the UE, and during which the UE may switch to the FBS 108, and the MBS may reduce its transmission power.

At operation 3, after receiving the relaying content, the UE 104 may launch a contention-free random access procedure during which the UE may transmit a message including a third specific random access code to the FBS 108. This third specific random access code may be pre-assigned during the aforementioned CoMP initialization, and may serve to notify the FBS that the UE will be relaying messages between the MBS and FBS. In response to the message including the third specific random access code, the FBS may transmit a random access response to the femto UE 104a. In an instance in which UL synchronization of the UE 104 with the FBS is not satisfactory, this response may include, at operation 4, a RAR message that may carry one or more physical parameters to adjust the UE's UL synchronization. In an instance in which the UE's synchronization is at least satisfactory, however, operation 4 may be omitted.

The random access response may also indicate a scheduled UL resource grant to the temporary identifier (e.g., C-RNTI), which the FBS 108 may transmit to the UE 104 on the FBS's PDCCH. This UL resource may be on the FBS's PUSCH, and may be scheduled by the FBS in response to the third specific random access code.

At operation 6, the UE 104 may forward the relaying content to the FBS 108 using the scheduled PUSCH resources of the FBS. The FBS may then use the relaying content to assume the controlling right of the UE at the determinate action time, thereby becoming the serving base station.

At operation 7, upon successful transmission of the relaying content, and following expiration of the gap scheduled by the MBS 102, the UE 104 may transmit a confirmation message to the MBS using the MBS's PUSCH. The UE may store the system information and synchronization information regarding the MBS after operation 1, and employ those parameters when transmitting the confirmation message. The MBS may have started pre-scheduling resources at operation 2. When the MBS receives the confirmation message indicating that the UE successfully relayed its relaying content, the MBS may terminate the UE connection and hand over the controlling right of the UE at the determinate action time. Otherwise, the MBS may assume that the UE relaying failed and continue providing the controls to the UE.

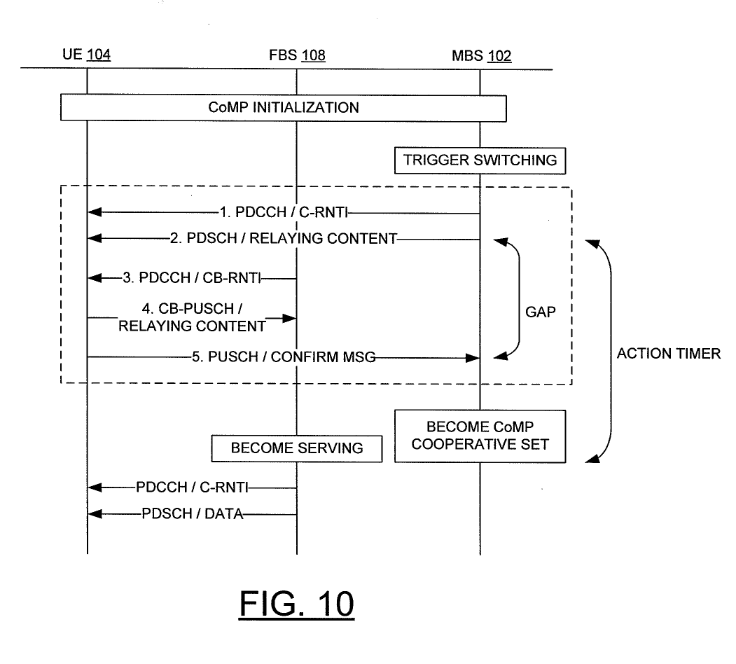

FIG. 10 is a control flow diagram illustrating messages that may be exchanged in the scenario illustrated in FIG. 8 to implement a process or function of UE relaying for CoMP, in accordance with another example embodiment of the disclosure. The embodiment of FIG. 10 may include initialization of CoMP and triggering of a switch from the MBS 102 to FBS 108, but may be equally applicable triggering a switch from the FBS to MBS, similar to the embodiment of FIG. 9.

Also similar to FIG. 9, the MBS 102 of FIG. 10 may trigger the switch from it to the FBS 108, and at operation 1, may use its PDCCH to transmit the temporary identifier (e.g., C-RNTI) assigned to the UE 104. Again, this identifier may guide the UE to receive data using the MBS's PDSCH.

Further similar to FIG. 9, at operation 2, the MBS 102 may transmit the relaying content to the UE 104 using the MBS's PDSCH. Similar to before, the relaying content may include an identifier (e.g., cell ID) of a BS to which the UE should switch (e.g., FBS 108), and may also include a SN, action timer or the like.

At operation 3, the FBS 108 may transmit a contention-based temporary identifier (e.g., CB-RNTI) to the UE 104 using the FBS's PDCCH. The contention-based temporary identifier may have been assigned to the UE during CoMP initialization, and may be mapped into a contention-based resource allocation in the FBS's PUSCH (e.g., so-called CB-PUSCH). This resource allocation may be shared with multiple UEs, but because the FBS may be expected to serve few UEs at any given instance, the UE may transmit content using the CB-PUSH with a lower likelihood of collision with transmissions from any other UEs using the CB-PUSH.

At operation 4, since the UE 104 may acquire synchronization information during initialization, UE may directly transmit the relaying content to the FBS 108 using the CB-PUSCH without performing random access and waiting for a RAR and associated resource grant. The FBS may use the relaying content to assume the controlling right of the UE at the determinate action time, thereby becoming the serving base station.

At operation 5 of FIG. 10, similar to operation 7 of FIG. 9, upon successful transmission of the relaying content, the UE 104 may transmit a confirmation message to the MBS 102 using the MBS's PUSCH. The MBS may have started pre-scheduling resources at operation 2. When the MBS receives the confirmation message indicating that the UE successfully relayed its relaying content, the MBS may terminate the UE connection and hand over the controlling right of the UE at the determinate action time. Otherwise, the MBS may assume that the UE relaying failed and continue providing the controls to the UE.

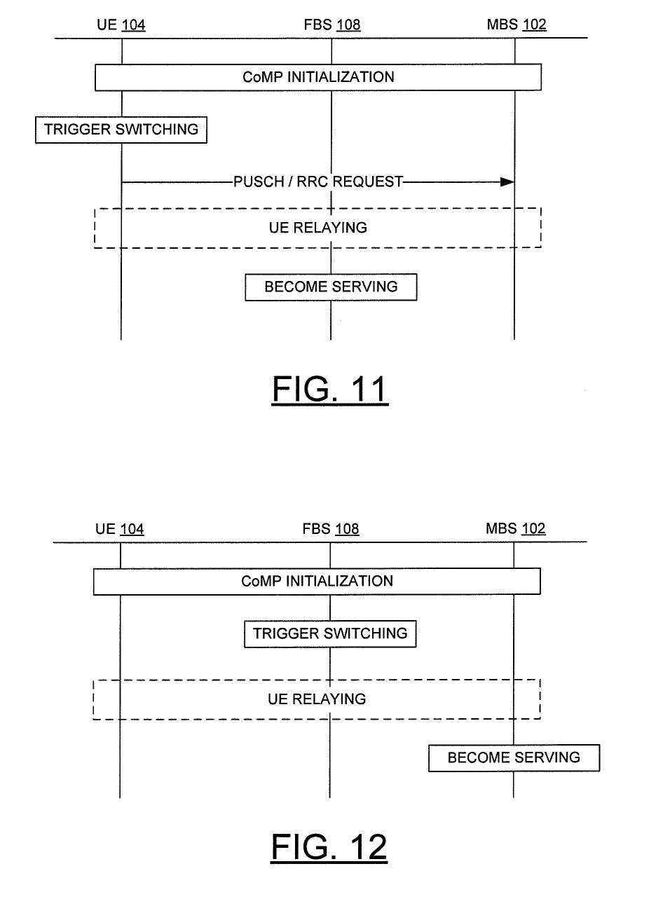

Through respective operations, the FBS 108 in the embodiments of FIGS. 9 and 10 may become the serving BS and provide corresponding PDSCH transmission to the UE 104 based on the SN status. The MBS 102, in turn, may become a CoMP candidate member which can be a target BS in a subsequent dynamic cell selection. In these examples, the MBS initiated the switching process from the MBS to the FBS. In other instances, the UE may trigger the switching, such as by transmitting a RRC request message to the MBS, following which the respective operations may be performed. An example of this is shown in FIG. 11. Further, example embodiments may equally perform a switch from the FBS to the MBS, such as in a manner similar to that shown in FIG. 12 where the FBS (or UE according to FIG. 11) may trigger a switch. In FIGS. 11 and 12, “UE relaying” may refer to operations 1-7 of FIG. 9 or operations 1-5 of FIG. 10.

According to one aspect of the disclosure, all or a portion of the network components shown in FIG. 1, including for example the MBS 102, UE 104 and/or FBS 108, may generally operate under control of one or more computer programs. The computer program for performing the methods of exemplary embodiments of the disclosure may include one or more computer-readable program code portions, such as a series of computer instructions, embodied or otherwise stored in a computer-readable storage medium, such as the non-volatile storage medium.

FIGS. 5-7 and 9-12 are control flow diagrams reflecting methods, systems and computer programs according to exemplary embodiments of the disclosure. It will be understood that each block or operation of the control flow diagrams, and combinations of blocks in the control flow diagrams, may be implemented by various means, such as hardware, firmware, and/or software including one or more computer program instructions. As will be appreciated, any such computer program instructions may be loaded onto a computer or other programmable apparatus to produce a machine, such that the instructions which execute on the computer or other programmable apparatus (e.g., hardware) create means for implementing the functions specified in the block(s) or operation(s) of the control flow diagrams. These computer program instructions may also be stored in a computer-readable memory that may direct a computer or other programmable apparatus to function in a particular manner, such that the instructions stored in the computer-readable memory produce an article of manufacture including instruction means which implement the function specified in the block(s) or operation(s) of the control flow diagrams. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the block(s) or operation(s) of the control flow diagrams.

Accordingly, blocks or operations of the control flow diagrams support combinations of means for performing the specified functions, combinations of operations for performing the specified functions and program instruction means for performing the specified functions. It will also be understood that one or more blocks or operations of the control flow diagrams, and combinations of blocks or operations in the control flow diagrams, may be implemented by special purpose hardware-based computer systems which perform the specified functions or operations, or combinations of special purpose hardware and computer instructions.

Many modifications and other embodiments of the invention will come to mind to one skilled in the art to which this invention pertains having the benefit of the teachings presented in the foregoing descriptions and the associated drawings. For example, it should be understood that the UE may additionally or alternatively use conventional X2-interface signaling at least partially to tunnel or otherwise transmit or receive relaying content. It should therefore be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. An apparatus comprising a processor configured to at least perform or cause the apparatus to at least perform:
receiving information at the apparatus operable as a user equipment, the information having been coordinated between a macro base station and a femto base station of a femtocell whose geographic area of coverage is at least partially overlapped by a macrocell including the macro base station, the information including a random access code;
preparing the random access code for transmission on a random access channel to the macro base station or femto base station as a first base station in an instance in which the other of the macro base station or femto base station as a second base station is serving the apparatus, the code serving to notify the first base station that the apparatus has been selected to relay content between the first base station and second base station; and
relaying content between the first base station and second base station, relaying content including receiving content from the first base station or second base station, and preparing the content for transmission to the second base station or first base station.

2. The apparatus of claim 1, wherein relaying content comprises relaying content without the apparatus establishing authorization or registering with the first base station, the first base station not requiring authorization or registration of the apparatus upon recognition of the random access code.

3. The apparatus of claim 1, wherein the macro base station is the first base station, and the femto base station is the second base station,
wherein receiving information includes receiving information further including an identifier assigned to the femto base station,
wherein the processor is further configured to at perform or cause the apparatus to perform: receiving a response indicating a scheduled resource grant to the identifier, and
wherein receiving content or preparing the content for transmission includes receiving content or preparing the content for transmission using the scheduled resource.

4. The apparatus of claim 3, wherein receiving a response includes receiving a response indicating a scheduled downlink resource grant to the temporary identifier, and
wherein receiving content includes receiving content from the macro base station using the scheduled downlink resource, and preparing the content for transmission includes preparing the content for transmission to the femto base station.

5. The apparatus of claim 3, wherein receiving a response includes receiving a response indicating a scheduled uplink resource grant to the identifier, and
wherein receiving content includes receiving content from the femto base station, and preparing the content for transmission includes preparing the content for transmission to the macro base station using the scheduled uplink resource.

6. The apparatus of claim 1, wherein preparing the random access code for transmission includes preparing the random access code for transmission as part of a random access procedure with the first base station to thereby synchronize with the first base station.

7. The apparatus of claim 1, wherein the macro base station is the first base station, and the femto base station is the second base station,
wherein receiving information includes receiving information further including synchronization information of the femto base station with the macro base station, and
wherein preparing the random access code for transmission and relaying content include preparing the random access code for transmission and relaying content re-using the synchronization information of the femto base station with the macro base station to synchronize the apparatus with the macro base station.

8. The apparatus of claim 7, wherein receiving content includes receiving content from the macro base station in a random access response message, and preparing the content for transmission includes preparing the content for transmission to the femto base station.

9. The apparatus of claim 1, wherein preparing the random access code for transmission and relaying content include preparing the random access code for transmission and relaying content in an instance in which the apparatus as the user equipment is cooperatively and switchably served by the macro base station and femto base station,
wherein receiving content from the macro base station or femto base station includes receiving an identifier assigned to the apparatus to guide the apparatus to receive content from the second base station on a shared channel, and thereafter receiving content from the second base station on the shared channel,
wherein preparing the random access code for transmission includes preparing the random access code for transmission to the first base station,
wherein the processor is further configured to at perform or cause the apparatus to perform: receiving a response to transmission of the random access code indicating a scheduled uplink resource grant to the identifier, and
wherein preparing the content for transmission includes preparing the content for transmission to the first base station using the scheduled uplink resource.

10. The apparatus of claim 1, wherein the processor is further configured to perform or cause the apparatus to perform:
receiving notification of a gap scheduled by the second base station during which the second base station will not schedule traffic to the apparatus.

11. The apparatus of claim 1, wherein receiving information includes receiving the random access code from the second base station based on content to be relayed between the first base station and second base station.

12. An apparatus comprising a processor configured to at least perform or cause the apparatus to at least perform:
coordinating information between the apparatus as a macro base station or a femto base station of a femtocell whose geographic area of coverage is at least partially overlapped by a macrocell including the macro base station, the other of the macro base station or femto base station being a second base station, the information including a random access code;
receiving the random access code on a random access channel from a user equipment in an instance in which the second base station is serving the user equipment, the code serving to notify the apparatus that the user equipment has been selected to relay content between the apparatus and second base station; and
participating in a relay of content, by the user equipment, between the apparatus and second base station, including:
preparing content for transmission to the user equipment to thereby enable the user equipment to transmit the content to the second base station, or
receiving content from the user equipment, the user equipment having received the content from the second base station for transmission to the apparatus.

13. The apparatus of claim 12, wherein relaying content comprises relaying content without the user equipment establishing authorization or registering with the apparatus, the apparatus not requiring authorization or registration of the user equipment upon recognition of the random access code.

14. The apparatus of claim 12, wherein the apparatus is the macro base station, and the second base station is the femto base station,
wherein coordinating information includes coordinating information further including an identifier assigned to the femto base station,
wherein the processor is further configured to at perform or cause the apparatus to perform: preparing a response for transmission to the user equipment, the response indicating a scheduled resource grant to the identifier, and
wherein receiving content or preparing the content for transmission includes receiving content or preparing the content for transmission using the scheduled resource.

15. The apparatus of claim 14, wherein the response indicates a scheduled downlink resource grant to the identifier, and
wherein preparing content for transmission includes preparing content for transmission to the user equipment using the scheduled downlink resource.

16. The apparatus of claim 14, wherein the response indicates a scheduled uplink resource grant to the identifier, and
wherein receiving content includes receiving content from the user equipment using the scheduled uplink resource.

17. The apparatus of claim 12, wherein receiving the random access code includes receiving the random access code as part of a random access procedure of the user equipment to thereby synchronize with the apparatus.

18. The apparatus of claim 12, wherein the apparatus is the macro base station, and the second base station is the femto base station,
wherein coordinating information includes coordinating information further including synchronization information of the second base station with the apparatus, and
wherein receiving the random access code and participating in a relay of content include receiving the random access code and participating in a relay of content with the user equipment re-using the synchronization information of the second base station with the apparatus to synchronize the user equipment with the apparatus.

19. The apparatus of claim 18, wherein participating in a relay of content includes preparing content for transmission to the user equipment in a random access response message.

20. The apparatus of claim 12, wherein receiving the random access code and participating in a relay of content include receiving the random access code and participating in a relay of content in an instance in which the user equipment is cooperatively and switchably served by the apparatus and second base station,
wherein receiving the random access code includes receiving the random access code,
wherein the processor is further configured to at perform or cause the apparatus to perform: preparing a response to the random access code for transmission to the user equipment, the response indicating a scheduled uplink resource grant to an identifier, the identifier having been assigned to the user equipment during the coordination of information, and
wherein participating in a relay of content includes receiving content from the user equipment using the scheduled uplink resource.

21. An apparatus comprising a processor configured to at least perform or cause the apparatus to at least perform:
coordinating information between the apparatus as a macro base station or a femto base station of a femtocell whose geographic area of coverage is at least partially overlapped by a macrocell including the macro base station, the other of the macro base station or femto base station being a second base station, the information including a random access code;
preparing the random access code for transmission to a user equipment in an instance in which the apparatus is serving the user equipment, the user equipment thereby being enabled to transmit the random access code to the second base station, the code serving to notify the second base station that the user equipment has been selected to relay content between the apparatus and second base station; and
participating in a relay of content, by the user equipment, between the apparatus and second base station, including:
preparing content for transmission to the user equipment to thereby enable the user equipment to transmit the content to the second base station, or
receiving content from the user equipment, the user equipment having received the content from the second base station for transmission to the apparatus.

22. The apparatus of claim 21, wherein the apparatus is the femto base station, and the second base station is the macro base station,
wherein coordinating information includes coordinating information further including synchronization information of the apparatus with the second base station, and
wherein preparing the random access code for transmission includes preparing a message for transmission to the user equipment, the message including the random access code and synchronization information, the user equipment thereby being enabled to re-use the synchronization information of the apparatus with the second base station to synchronize the user equipment with the second base station.

23. The apparatus of claim 21, wherein the processor is further configured to at perform or cause the apparatus to perform:
scheduling a gap during which the apparatus will not schedule traffic to the user equipment.

24. The apparatus of claim 21, wherein coordinating information includes assigning the random access code to the user equipment based on content to be relayed between the apparatus and second base station.

25. A method comprising operations performed by an apparatus including a processor configured to at least perform or cause the apparatus to at least perform the respective operations, including:
receiving information at the apparatus operable as a user equipment, the information having been coordinated between a macro base station and a femto base station of a femtocell whose geographic area of coverage is at least partially overlapped by a macrocell including the macro base station, the information including a random access code;
preparing the random access code for transmission on a random access channel to the macro base station or femto base station as a first base station in an instance in which the other of the macro base station or femto base station as a second base station is serving the apparatus, the code serving to notify the first base station that the apparatus has been selected to relay content between the first base station and second base station; and
relaying content between the first base station and second base station, relaying content including receiving content from the first base station or second base station, and preparing the content for transmission to the second base station or first base station.

26. The method of claim 25, wherein relaying content comprises relaying content without the apparatus establishing authorization or registering with the first base station, the first base station not requiring authorization or registration of the apparatus upon recognition of the random access code.

27. The method of claim 25, wherein the macro base station is the first base station, and the femto base station is the second base station,
wherein receiving information includes receiving information further including an identifier assigned to the femto base station,
wherein the operations further include receiving a response indicating a scheduled resource grant to the identifier, and
wherein receiving content or preparing the content for transmission includes receiving content or preparing the content for transmission using the scheduled resource.

28. The method of claim 27, wherein receiving a response includes receiving a response indicating a scheduled downlink resource grant to the identifier, and
wherein receiving content includes receiving content from the macro base station using the scheduled downlink resource, and preparing the content for transmission includes preparing the content for transmission to the femto base station.

29. The method of claim 27, wherein receiving a response includes receiving a response indicating a scheduled uplink resource grant to the identifier, and
wherein receiving content includes receiving content from the femto base station, and preparing the content for transmission includes preparing the content for transmission to the macro base station using the scheduled uplink resource.

30. The method of claim 25, wherein preparing the random access code for transmission includes preparing the random access code for transmission as part of a random access procedure with the first base station to thereby synchronize with the first base station.

31. The method of claim 25, wherein the macro base station is the first base station, and the femto base station is the second base station,
wherein receiving information includes receiving information further including synchronization information of the femto base station with the macro base station, and
wherein preparing the random access code for transmission and relaying content include preparing the random access code for transmission and relaying content re-using the synchronization information of the femto base station with the macro base station to synchronize the apparatus with the macro base station.

32. The method of claim 31, wherein receiving content includes receiving content from the macro base station in a random access response message, and preparing the content for transmission includes preparing the content for transmission to the femto base station.

33. The method of claim 25, wherein preparing the random access code for transmission and relaying content include preparing the random access code for transmission and relaying content in an instance in which the apparatus as the user equipment is cooperatively and switchably served by the macro base station and femto base station,
wherein receiving content from the macro base station or femto base station includes receiving an identifier assigned to the apparatus to guide the apparatus to receive content from the second base station on a shared channel, and thereafter receiving content from the second base station on the shared channel,
wherein preparing the random access code for transmission includes preparing the random access code for transmission to the first base station,
wherein the operations further include receiving a response to transmission of the random access code indicating a scheduled uplink resource grant to the identifier, and
wherein preparing the content for transmission includes preparing the content for transmission to the first base station using the scheduled uplink resource.

34. The method of claim 25, wherein the operations further include:
receiving notification of a gap scheduled by the second base station during which the second base station will not schedule traffic to the apparatus.

35. The method of claim 25, wherein receiving information includes receiving the random access code from the second base station based on content to be relayed between the first base station and second base station.

36. A method comprising operations performed by an apparatus including a processor configured to at least perform or cause the apparatus to at least perform the respective operations, including:
coordinating information between the apparatus as a macro base station or a femto base station of a femtocell whose geographic area of coverage is at least partially overlapped by a macrocell including the macro base station, the other of the macro base station or femto base station being a second base station, the information including a random access code;
receiving the random access code on a random access channel from a user equipment in an instance in which the second base station is serving the user equipment, the code serving to notify the apparatus that the user equipment has been selected to relay content between the apparatus and second base station; and
participating in a relay of content, by the user equipment, between the apparatus and second base station, including:
preparing content for transmission to the user equipment to thereby enable the user equipment to transmit the content to the second base station, or
receiving content from the user equipment, the user equipment having received the content from the second base station for transmission to the apparatus.

37. The method of claim 36, wherein relaying content comprises relaying content without the user equipment establishing authorization or registering with the apparatus, the apparatus not requiring authorization or registration of the user equipment upon recognition of the random access code.

38. The method of claim 36, wherein the apparatus is the macro base station, and the second base station is the femto base station,
wherein coordinating information includes coordinating information further including an identifier assigned to the femto base station,
wherein the operations further include preparing a response for transmission to the user equipment, the response indicating a scheduled resource grant to the identifier, and
wherein receiving content or preparing the content for transmission includes receiving content or preparing the content for transmission using the scheduled resource.

39. The method of claim 38, wherein the response indicates a scheduled downlink resource grant to the identifier, and
wherein preparing content for transmission includes preparing content for transmission to the user equipment using the scheduled downlink resource.

40. The method of claim 38, wherein the response indicates a scheduled uplink resource grant to the identifier, and
wherein receiving content includes receiving content from the user equipment using the scheduled uplink resource.

41. The method of claim 36, wherein receiving the random access code includes receiving the random access code as part of a random access procedure of the user equipment to thereby synchronize with the apparatus.

42. The method of claim 36, wherein the apparatus is the macro base station, and the second base station is the femto base station,
wherein coordinating information includes coordinating information further including synchronization information of the second base station with the apparatus, and
wherein receiving the random access code and participating in a relay of content include receiving the random access code and participating in a relay of content with the user equipment re-using the synchronization information of the second base station with the apparatus to synchronize the user equipment with the apparatus.

43. The method of claim 42, wherein participating in a relay of content includes preparing content for transmission to the user equipment in a random access response message.

44. The method of claim 36, wherein receiving the random access code and participating in a relay of content include receiving the random access code and participating in a relay of content in an instance in which the user equipment is cooperatively and switchably served by the apparatus and second base station,
wherein receiving the random access code includes receiving the random access code,
wherein the operations further include preparing a response to the random access code for transmission to the user equipment, the response indicating a scheduled uplink resource grant to an identifier, the identifier having been assigned to the user equipment during the coordination of information, and
wherein participating in a relay of content includes receiving content from the user equipment using the scheduled uplink resource.

45. A method comprising operations performed by an apparatus including a processor configured to at least perform or cause the apparatus to at least perform the respective operations, including:
coordinating information between the apparatus as a macro base station or a femto base station of a femtocell whose geographic area of coverage is at least partially overlapped by a macrocell including the macro base station, the other of the macro base station or femto base station being a second base station, the information including a random access code;
preparing the random access code for transmission to a user equipment in an instance in which the apparatus is serving the user equipment, the user equipment thereby being enabled to transmit the random access code to the second base station, the code serving to notify the second base station that the user equipment has been selected to relay content between the apparatus and second base station; and
participating in a relay of content, by the user equipment, between the apparatus and second base station, including:
preparing content for transmission to the user equipment to thereby enable the user equipment to transmit the content to the second base station, or
receiving content from the user equipment, the user equipment having received the content from the second base station for transmission to the apparatus.

46. The method of claim 45, wherein the apparatus is the femto base station, and the second base station is the macro base station,
wherein coordinating information includes coordinating information further including synchronization information of the apparatus with the second base station, and
wherein preparing the random access code for transmission includes preparing a message for transmission to the user equipment, the message including the random access code and synchronization information, the user equipment thereby being enabled to re-use the synchronization information of the apparatus with the second base station to synchronize the user equipment with the second base station.

47. The method of claim 45, wherein the operations further include:
scheduling a gap during which the apparatus will not schedule traffic to the user equipment.

48. The method of claim 45, wherein coordinating information includes assigning the random access code to the user equipment based on content to be relayed between the apparatus and second base station.
